(19) United States
(12) Patent Application Publication
(10) Pub. No.: US 2014/0010955 A1
(43) Pub. Date: Jan. 9, 2014

(54) METHOD OF PRODUCING ALPHA-FE/R2TM14B-TYPE NANOCOMPOSITE MAGNET

(71) Applicants: Fumitoshi YAMASHITA, Kitasaku-gun (JP); Shiho OHYA, Kitasaku-gun (JP); Shinsaku NISHIMURA, Kitasaku-gun (JP)

(72) Inventors: Fumitoshi YAMASHITA, Kitasaku-gun (JP); Shiho OHYA, Kitasaku-gun (JP); Shinsaku NISHIMURA, Kitasaku-gun (JP)

(73) Assignee: MINEBEA CO., LTD., Kitasaku-gun (JP)

(21) Appl. No.: 13/584,304

(22) Filed: Aug. 13, 2012

(30) Foreign Application Priority Data
Aug. 17, 2011 (JP) 2011-178358

(51) Int. Cl. H01F 41/02

(52) U.S. Cl. CPC H01F 41/02
USPC 427/127; 164/460

(57) ABSTRACT

There is provided a method of producing an α-Fe/R₂TM₁₄B-type nanocomposite magnet where R is 9 at. % or more but less than 11.76 at. % of Nd or Pr, TM is Fe or a substance in which a portion of Fe is substituted with Co of 20 at. % or less, and B is 6 to 8 at. %. A relatively long length nanocrystalline ribbon having a coercivity of 600 kA/m or more in which a content of flakes of less than 10 mm in length is 20% or less is coated with a polymeric film and then cut into an intended length, or punched into a specific shape.

### BACKGROUND OF THE INVENTION

1. Field of the Invention

The present invention relates to a method of producing a nanocomposite magnet in which a relatively long length nanocrystalline α-Fe/R₂TM₁₄B-type ribbon that has excellent magnetic stability is directly, or as a ribbon coated with a polymeric film, cut into an intended length, or punched into a specific shape.

2. Description of the Related Art

With regard to a nanocomposite magnet ribbon which can be produced by subjecting a relatively long length ribbon directly, or as a resin composite rare earth-iron-type ribbon to cutting to have a prescribed length or punching to have an specific shape, for example, Japanese Patent Application Laid-Open (JP-A) No. Hei 11-026272 discloses the following: a method of producing a nanocomposite magnet having an arbitrary thickness or a desired shape without using a method of crushing a ribbon or flakes or making a ribbon or flakes into a bonded magnet, in which a B(boron)-rich molten alloy such as alloy compositional formula Fe_{100-x-y}RxAy (wherein R is one or more of Pr, Nd, Dy, and Tb; A is one or two of C (carbon) or B (boron); 1≦x<6 atomic % (hereinafter “at. %”); and 15≦y≦30 at. %) is made into a ribbon having a thickness of 10 to 100 μm and at least 90% amorphous phase under specific rapid solidification conditions. Next, utilizing the excellent toughness and elastic deformability, the ribbon is subjected directly, or after cutting into a prescribed length or punching into an arbitrary shape, to a heat treatment of 550 to 750° C. that renders the amorphous texture into a nanocrystalline texture having an average grain size of 10 to 50 nm in which an Fe₃B phase and an Nd₂Fe₁₄B phase are mixed, to yield a nanocrystalline ribbon having a coercivity of 160 kAJm or more and a remanence of 0.8 T or more. Two or more of the nanocrystalline ribbons are then laminated, and then the laminated nanocrystalline ribbons are adhered and integrated to each other with an epoxy resin.

JP-A No. Hei 11-016715 discloses the following: a method of producing a nanocomposite magnet in which a B(boron)-rich molten alloy as mentioned above is rapidly solidified into a ribbon having a thickness of 10 to 100 μm and including an amorphous texture of 90% or more, and then a metal having a melting point of 200 to 550° C. is plated or deposited onto the surface of the ribbon. The quenched ribbons are then laminated directly, or after working into a specific shape, and subjected to a heat treatment of 550 to 750° C. that renders the amorphous texture into a nanocrystalline texture having an average grain size of 10 to 50 nm in which an Fe₃B phase, an α-Fe phase, and an Nd₂Fe₁₄B phase are mixed, and the metallic layers on the surface of the ribbons are simultaneously melted to integrate the ribbons.

JP-A No. 2001-254159 discloses the following: a method of producing a ribbon nanocomposite magnet that has a texture with an average grain diameter of 50 nm or less including R₂Fe₁₄B, Fe₃B, and α-Fe phases and a residual amorphous phase, a remanence Mr of 1 T or more, a coercivity of 150 kA/m or more, and a thickness of 200 to 300 μm. The alloy of the nanocomposite magnet has a composition of Fe_{100-y-z}Co₁₀RyBz or Fe_{100-y-z}Co_{9.5}TM₂RyBz (wherein TM is one or more elements selected from V, Ti, Cr, Mn, Cu, Nb, Mo, W, Ta, Hf, and Zr; R is one or more elements selected from rare earth elements; B is boron; y and z which indicate composition ratios are in atomic percentages such that 2.5<y<4.0 and 19<z<25), a temperature spacing ΔTx in a supercooled liquid zone represented by the formula ΔTx=Tx−Tg (wherein, Tx is the initial crystallization temperature and Tg is the glass transition temperature) of 35° C. or more, and a reduced vitrification temperature represented by the formula Tg/Tm (wherein Tm is the melting temperature of the alloy) of 0.55 or more. The alloy is produced by heat treating a metallic glass alloy obtained by a single roller rapid solidification method having a thickness of 200 to 300 μm and a volume ratio of the amorphous phase of 90% or more.

The B (boron) content in JP-A Nos. 11-026272 and 11-016715 is 15≦B≦30 at. %, and the B (boron) content in JP-A No. 2001-254159 is 19<B<25 at. %. The reason for a B(boron)-richness on this level is that it is necessary for amorphous formation of 90% or more, and that a long amorphous ribbon can be easily produced by making the B (boron) content about 2.5 times or more or about 3 times or more than R₂TM₁₄B stoichiometry. Therefore, a ribbon nanocomposite magnet can be treated directly, or subjected to cutting to have a prescribed length or punching to have a specific shape.

However, when PrxFe₈₃₋ₓCo₈V₁Nb₁B₇ (x=2 to 7), in which the content of B (boron) is 6 to 8 at. % near R₂TM₁₄B stoichiometry, is made into a molten alloy of, for example, approximately 1400° C. and then rapidly solidified, the ribbon shape (ribbon shape) has a width and length on the order of several mm and a thickness on the order of several tens of μm (refer to JP-A No. 2003-277892). In this way, when the B (boron) content is near R₂TM₁₄B stoichiometry, a ribbon with a length on the order of only several mm can be obtained. Therefore, a quenched ribbon or flakes made from such an alloy composition is made into an arbitrary thickness or a desired shape using a bonded magnet method in which the ribbon or flakes are crushed and then hardened together with a resin.

Meanwhile, the range of coercivity of the B(boron)-rich nanocomposite magnets disclosed in JP-A Nos. 11-026272 and 11-016715, which are related to a long amorphous ribbon, is 160 to 568 kA/m, and the range is 171 to 284 kA/in in JP-A No. 2001-254159. The cause of such low coercivity is that in all of JP-A Nos. 11-026272, 11-016715, and 2001-254159, when the amorphous phase is nanocrystalline, a fine crystal texture is formed in which at least the three phases of Fe₃B, α-Fe, and Nd₂Fe₁₄B are mixed. However, the upper limit of the rare earth element R that forms a hard phase is limited to 6 at. %, which is approximately ½ or less of R₂TM₁₄B stoichiometry (refer to JP-A Nos. 11-026272 and 11-016715), or the upper limit of the rare earth element R is limited to 4 at. %, which is approximately ⅓ or less of R₂TM₁₄B stoichiometry (refer to JP-A No. 2001-254159). In this way, the remanence of a nanocomposite magnet with a B(boron)-rich alloy composition in which the rare earth element is 7 at. % or less can be improved by increasing the content of the soft phase, but a high coercivity exceeding 600 kA/m cannot be obtained.

In a motor, actuator, sensor, or the like utilizing magnetic torque of the B(boron)-rich nanocomposite magnets disclosed in JP-A Nos. 11-026272, 11-016715, and 2001-254159, there are defects in the magnetic stability such as torque linearity relative to an external magnetic field, distortion in the torque curve, or initial irreversible flux loss due to heat, given the level of coercivity. Therefore, such magnetic stability may have a great influence on the operation and reliability of the motor, actuator, sensor, or the like.

For example, a motor configured as a high permeance magnetic circuit using a high remanence-type B(boron)-rich nanocomposite magnet having a remanence of 1 T or more as disclosed in JP-A Nos. 11-026272, 11-016715, and 2001-254159 can achieve a higher torque than a bonded magnet motor produced from a nanocrystalline ribbon near R₂TM₁₄B stoichiometry. However, such a motor exhibits problems in view of so-called magnetic stability such as linearity in current (external magnetic field such as a rotating magnetic field) versus torque, position control (servomotor) which requires a sinusoidal torque curve, or initial irreversible flux loss in exposure to high temperature. Further, in a use in which a high permeance magnetic circuit would pose structural difficulties, it has been difficult to utilize the advantages of a high remanence-type B(boron)-rich nanocomposite magnet.

### SUMMARY OF THE INVENTION

An object of the present invention is to provide a method of producing a nanocomposite magnet in which a relatively long length α-Fe/R₂TM₁₄B-type ribbon that has excellent magnetic stability is subjected directly, or as a ribbon coated with a polymeric film, to cutting to have a prescribed length, or punching to have a specific shape, and thereby increasing the high torqueing or reliability of a motor, actuator, sensor, or the like.

The embodiments of the invention described below are examples of the structure of the present invention. In order to facilitate the understanding of the various structures of the present invention, the explanations below are divided into aspects. Each aspect does not limit the technical scope of the present invention, and the technical scope of the present invention can also include structures in which a portion of the components in the aspects below are substituted or deleted, or another component is added upon referring to the best modes for carrying out the invention.

According to a first aspect of the present invention, there is provided a method of producing an α-Fe/R₂TM₁₄B-type (where R is 9 at. % or more but less than 11.76 at. % of Nd or Pr, TM is Fe or a substance in which a portion of Fe is substituted with Co of 20 at. % or less, and B is 6 to 8 at. %) nanocomposite magnet, wherein a relatively long nanocrystalline ribbon having a coercivity of 600 kA/m or more in which a content of flakes of less than 10 mm in length is 20% or less is coated with a polymeric film and then cut into an intended length, or punched into a specific shape.

With this structure, instead of rapidly solidifying a molten alloy that is B(boron)-rich compared to R₂TM₁₄B stoichiometry like those in JP-A Nos. 11-026272, 11-016715, and 2001-254159 into a ribbon having an amorphous phase of 90% or more, and thereby yielding a desired magnet by appropriately cutting the ribbon as necessary, mechanically working it into a specific shape, and laminating it, the present invention provides a method of producing an α-Fe/R₂TM₁₄B-type nanocomposite magnet in which, by requiring 6 to 8 at. % of B (boron) and 9 at. %, a relatively long length nanocrystalline α-Fe/R₂TM₁₄B-type ribbon that has excellent magnetic stability and a coercivity of 600 kA/m or more is obtained, and this ribbon is coated with a polymeric film and then cut into an intended length, or punched into a specific shape and then laminating.

The magnetic stability according to this aspect of the present invention is based on a coercivity of 600 kA/m or more. Further, the relatively long length ribbon according to this aspect of the present invention indicates a ribbon having a length of 10 mm or more that is coated with a polymeric film and then cut into an intended length, or punched into a specific shape. Specifically, when preparing the ribbon, a nanocrystalline α-Fe/R₂TM₁₄B-type ribbon including less than 20% of flakes under 10 mm in length is used. Flakes generated during production can be pulverized and used as a raw material for bonded magnets that is hardened together with a resin.

In the method of producing an α-Fe/R₂TM₁₄B-type nanocomposite magnet according to the first aspect, the nanocrystalline ribbon may be produced by rapidly solidifying at a roller surface contact distance of 10 to 15 mm from a puddle of an R-TM-B-type molten alloy of 1300° C. or more formed in a vertical direction (apex) of a copper single roller with a diameter of 500 mm or more whose surface moves at a circumferential velocity of 14 to 15 m/sec in an argon gas atmosphere of 50 to 90 kPa.

With this structure, a liquid rapid solidification apparatus is used for the preparation of the relatively long length nanocrystalline α-Fe/R₂TM₁₄B-type ribbon that has excellent magnetic stability. More preferably, a puddle of a R-TM-B-type molten alloy of 1300° C. or more is formed to reach a steady state in a vertical direction (apex) of a copper single roller with a diameter of 500 mm or more that rotates at a circumferential velocity of 14 to 15 m/sec in an argon gas atmosphere of 50 to 90 kPa, and further adjustments are made so that rapid solidification is carried out with a roller surface contact distance Lₑₙ, in the range of 10 to 15 mm.

In the method of producing an α-Fe/R₂TM₁₄B-type nanocomposite magnet according to the first aspect, an angle formed by a circumferential direction tangent line that contacts the roller at the center of the puddle and a chord of a contact curve drawn by the ribbon from the puddle to a separation point may be 1.7° or less.

With this structure, when an angle formed by a circumferential direction tangent line that contacts the roller at the center of the formed puddle and a chord of a ribbon contact curve drawn from the puddle to a separation point is θ, θ is set to 1.7° or less. Thereby, a relatively long length nanocrystalline ribbon having a coercivity of 600 kA/m or more and an average thickness of 40 to 45 μm in which the main phases are an α-Fe phase that was phase transformed from γ-Fe and a R₂TM₁₄B phase with an average grain size of 10 to 50 urn is obtained.

In the method of producing an α-Fe/R₂TM₁₄B-type nanocomposite magnet according to the first aspect, a distortion rate of a magnetic torque curve in an external magnetic field of 40 kA/m of a circular plate of the nanocrystalline ribbon that is magnetized in an in-plane direction at 2.4 MA/m or more may be 1.2% or less.

With this structure, the distortion rate of a torque curve in an external magnetic field of 40 kA/m of an isotropic circular plate sample that is magnetized in an in-plane direction at 2.4 MA/m or more is 1.2% or less, and the reversibility and linearity of the torque relative to an external magnetic field such as a rotating magnetic field are also secured. Thereby, the obtained magnet is an α-Fe/R₂TM₁₄B-type nanocomposite magnet but also achieves excellent magnetic stability in practical use, such as an initial irreversible flux loss due to heat that is approximately on the same level as that of a nanocrystalline ribbon near R₂TM₁₄B stoichiometry or a bonded magnet made by pulverizing flakes and hardening them with a resin.

In the method of producing an α-Fe/R₂TM₁₄B-type nanocomposite magnet according to the first aspect, the nanocrystalline ribbon that flies may be collected with a flat chute.

With this structure, a nanocrystalline ribbon that flies during separation from the roller of the liquid rapid solidification device is collected with a flat chute.

With the structures described above, the present invention provides a method of producing a nanocomposite magnet in which a relatively long length α-Fe/R₂TM₁₄B-type ribbon that has excellent magnetic stability is subjected directly, or a ribbon coated with a polymeric film, to cutting to have a prescribed length, or punching to have a specific shape so as to increase the high torque or reliability of a motor, actuator, sensor, or the like.

### BRIEF DESCRIPTION OF THE DRAWINGS

FIG. 1A is an R—Fe—B-type pseudo binary phase diagram along an R/B=2 tie line, and FIG. 1B is a perspective view of the essential parts in rapid solidification;

FIG. 2A is a characteristics graph illustrating the distribution of ribbon lengths, and FIG. 2B is a characteristics graph illustrating the relationship between the roller diameter and the ribbon rotation angle;

FIG. 3A is a characteristics graph illustrating the relationship between the coercivity and the film thickness, and FIG. 3B is a characteristics graph illustrating the relationship between the heat treatment temperature and the coercivity;

FIG. 4A is a characteristics graph illustrating the external magnetic field dependency of the torque, and FIG. 4B is a characteristics graph illustrating the external magnetic field dependency of the torque curve distortion rate; and

FIG. 5 is a characteristics graph illustrating the coercivity dependency of the torque curve distortion rate and the initial irreversible flux loss rate.

### DETAILED DESCRIPTION OF THE PREFERRED EMBODIMENTS

The relatively long ribbon according to the present invention is preferably a magnetically isotropic α-Fe/R₂TM₁₄B-type nanocrystalline ribbon in which the grain size range of the main phases including an a-Fe phase and a R₂TM₁₄B phase is controlled to approximately 10 to 50 nm. In such a ribbon, the remanence is increased due to remanence enhancement effect. For example, D. Goll et al. reported that when a molten alloy having an alloy composition of Pr₈Fe₈₇B₅ is rapidly solidified so that the grain size of the α-Fe phase is approximately 15 nm and the grain size of the Pr₁₂Fe₁₄B phase is 20 to 30 nm, sufficient magnetic coupling occurs at the contact interface between the α-Fe phase and the Pr₁₂Fe₁₄B phase, and a remanence of 1.17 T, a coercivity of 470 kA/m, and a (BH)ₘₐₓ of 180.7 kJ/m³ can be obtained (refer to D. Goll, L Kleinschroth, H. Kronmuller, Proc. 17^{th} Int. Workshop on Rare-Earth Magnets and Their Applications, Vol. 2, pp. 641-657 (2000) (hereinafter referred to as “Goll Reference”)).

The initial irreversible flux loss due to deterioration of the flux loss curve at high temperature of the above-described nanocomposite magnet can be generally suppressed as long as the coercivity is 600 kA/m or more. The initial irreversible flux loss is controlled by the level of coercivity and a temperature coefficient ΔHcJ/ΔT (%/° C.) of the coercivity. For example, in an environment of up to 120° C., a practical level of magnetic stability can be secured in a magnet mounted on a motor or the like (refer to F. Yamashita, K. Takasugi, H. Yamamoto, H. Fukunaga, Transaction on Magn. Soc. Japan, Vol. 2, No. 2, pp. 32-35 (2002) (hereinafter referred to as “Yamashita Reference”).

However, even if Pr is 8 at. % (Pr₅Fe₈₇13₅), the coercivity only reaches 470 kA/m (refer to Goll Reference), and when Pr is 6 at. % (Pr₆F_{86-x-y-z}Co₈VₓNb_{y}B_{z}, x=0 to 4, y=0 to 3, and z=6 to 9), the coercivity only reaches 365 kA/m. Thus, in the present invention, R is 9 at. % or more, and B (boron) is 6 to 8 at. %, and thereby the coercivity is 600 kA/m or more. However, since the nanocomposite magnet according to the present invention has an α-Fe phase, it is necessary to set the upper limit of R to less than 11.76 at. % in R₂TM₁₄B stoichiometry. Also, Fe can be replaced with Co of 20 at. % or less. The Co substation of Fe can raise the Curie temperature by approximately 10° C. for each 1 at. %, and can adjust the temperature coefficient of remanence. To improve the temperature coefficient ΔHcJ/ΔT (%/° C.) of the coercivity together with the coercivity value that affects the initial flux loss, or to improve the remanence by remanence enhancement effect, it is necessary to refine the main phase like that in the Yamashita Reference. It is also normally effective to add approximately 1 at. % of Nb (refer to Zhongmin Chena, Y. Q. Wub, M. J. Kramer, Benjamin R. Smitha, Bao-Min Maa, Mei-Qing Huang, Journal of Magnetism and Magnetic Materials, Vol. 268, pp. 105-113 (2004)) or Nb and V (refer to JP-A No. 2003-277892) as a fourth element (grain boundary) that suppresses grain growth during rapid solidification.

At a coercivity level like that described above, the linearity of magnetic torque in an external magnetic field of 240 kA/m or less at room temperature of a circular plate sample that is magnetized in an in-plane direction at two poles is 0.9999 or more when expressed as a correlation coefficient R, and the distortion rate of the torque curve at 40 kA/m is 1.15% or less. In order to achieve a coercivity of 600 kA/m or more in the α-Fe/R₂TM₁₄B-type nanocomposite magnet of the present invention, R of less than R₂TM₁₄B stoichiometry must be 9 at. % or more and B (boron) must be 6 to 8 at. %.

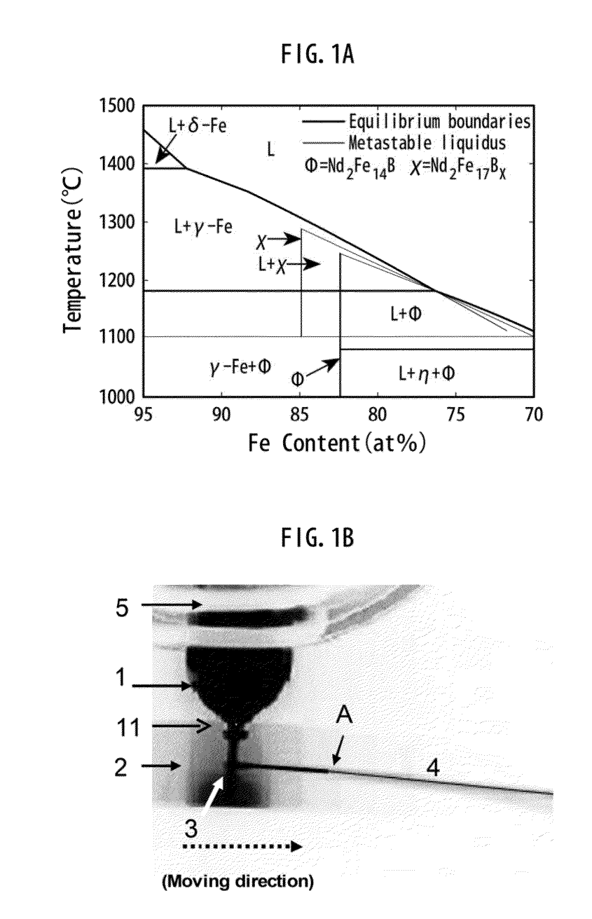

Next, a preferred method of producing the α-Fe/R₂TM₁₄B-type nanocomposite magnet of the present invention will be explained referring to FIGS. 1A and 1B. FIG. 1A is an R-TM-B-type pseudo binary phase diagram along a tie line in which RB (ratio of Nd or Pr and B) is 2, and FIG. 1B is a perspective view of the essential parts in rapid solidification. In FIG. 1A, the Co substitution amount of a portion of Fe is constant. In FIG. 1B, 1 denotes a molten alloy, 11 denotes a nozzle (orifice), 2 denotes a roller surface, 3 denotes a puddle, 4 denotes a ribbon, A denotes a separation point of the ribbon 4 from the roller surface 2, and 5 denotes a coil.

From the R-TM-B-type pseudo binary phase diagram along an R/B=2 tie line in FIG. 1A, the molten alloy 1 is 1300° C. or more. In rapid solidification of such a molten alloy 1, it is assumed that a γ-Fe+R₂Fe₁₄B zone is reached after first passing through a liquid phase+γ-Fe zone. γ-Fe phase transforms into α-Fe in the course of being cooled to room temperature to yield a rapidly solidified ribbon in which the main phases are an α-Fe phase and a R₂Fe₁₄B phase.

For example, in an argon gas atmosphere of 50 to 90 kPa (not illustrated), rapid solidification forms a puddle 3 of a R-TM-B-type molten alloy 1 of 1300° C. or more in a vertical direction (apex) of a copper single roller surface 2 with a diameter of 500 mm or more that rotates at a circumferential velocity of 14 to 15 m/sec. The ribbon 4 rapidly solidified from the puddle 3 is subjected to heat removal by the roller surface 2 until the separation point A. The ribbon 4 which has separated from the roller surface 2 at the separation point A is further cooled in the argon gas atmosphere to become a nanocrystalline quenched ribbon 4 with a coercivity of 600 kA/m or more in which the main phases are an γ-Fe phase (phase transformed to α-Fe) and a R₂TM₁₄B phase with an average crystal grain diameter of 10 to 50 nm.

In order to stably perform rapid solidification in the present invention as described above, it is necessary to stably form the puddle 3 of the molten alloy 1 between the nozzle 11 that is a supply source of the molten alloy 1 and the copper roller surface 2 that moves. Such a puddle 3 of the molten alloy 1 can be formed if the molten alloy 1 is supplied upon plug flowing at a pressure within a fixed range, such as 30 to 50 kPa, through the nozzle (orifice) 11 heated to or above the melting point by a method such as electrifying the coil 5 with a high frequency current. In other words, the molten alloy 1 is rapidly solidified into the ribbon 4, and stability of the puddle 3 can be achieved by supplying the molten alloy 1 to match an amount that is carried away by the movement of the roller.

If the size of the puddle 3 exceeds a certain fixed range, the formation of the puddle 3 becomes unstable, and a steady state cannot be maintained. Further, in order to maintain the stability of the puddle 3, it is important for the cooling capacity of the cooling roller to be stable with no losses.

A solidification interface movement velocity Ni_{sld} of the stable puddle 3 described above changes by a heat transfer coefficient between the molten alloy 1 and the roller surface 2. For example, when the puddle 3 of a Pr₉Fe₇₃Co₉ B₇V₁Nb₁ molten alloy 1 of 1300° C. or more was formed in a vertical direction (apex) of the copper single roller surface 2 with a diameter of 500 mm that rotated at a circumferential velocity of 14.5 m/sec and then rapidly solidified, the average thickness of the ribbon 4 was 42 μm. The distance from the puddle 3 to the separation point A of the formed ribbon 4, or in other words a contact distance L_{cnt} between the ribbon 4 and the roller surface 2, was approximately 12.0 to 12.5 mm. Therefore, the solidification interface movement velocity V_{sld} was 50 min/sec, and the contact time of the ribbon 4 and the roller surface 2 was 0.84 msec. Further, if the temperature when the molten alloy 1 of 1300° C. separates from the roller surface 2 as the ribbon 4 is 700 to 800° C., the cooling speed during rapid solidification becomes approximately 7×10⁵ to 6×10⁵° C./sec.

When forming the relatively long ribbon 4 of the present invention, it is necessary to reduce the trajectory of the arc shape of the ribbon 4 in the contact distance L_{cnt}. For example, when an angle formed by a circumferential direction tangent line of the puddle 3 and a chord of an arc drawn by the ribbon 4 in which the puddle 3 is the start point and the separation point A is the end point is θ, the linearity of the ribbon 4 that contacts the roller surface 2 increases as the angle θ decreases. In the present invention, it was found that if θ is approximately 1.4° or less, the position of the separation point A stabilizes and it becomes easier to obtain the relatively long ribbon 4.

The ribbon 4 that has passed the separation point A flies in the argon gas atmosphere of 50 to 90 kPa, and is rapidly cooled until at or below R₂TM₁₄B (crystallization temperature of approximately 590° C.) and α-Fe (crystallization temperature of approximately 420° C.). The ribbon 4 is then preferably collected by a flat chute. A ribbon of a B(boron)-rich alloy composition as disclosed in JP-A Nos. 11-026272, 11-016715, and 2001-254159 normally becomes a continuous ribbon 4, but twisting and warping normally occur. The reason for collecting the ribbon 4 with a flat chute is to suppress twisting and warping that occur upon impacting a side wall or suppressing formation of flakes that are crushed in the ribbon 4 according to the present invention which flies linearly, and to increase the yield of the relatively long length ribbon. By suppressing twisting and warping of the ribbon as described above, the ribbon can be easily subjected directly to, or as a ribbon coated with a polymeric film, cutting into an intended length, or being punched into a specific shape.

Next, the mechanical working of the α-Fe/R₂TM₁₄B-type nanocomposite magnet according to the present invention will be explained. As mechanical working of the ribbon according to the present invention, supersonic machining, microblast machining, and the like can be used. Preferably, the mechanical working is punching using a precise punching die such as a fineblanking method, a shaving method, or the like. More preferably, the mechanical working is precise punching by an opposing dies method.

### EMBODIMENTS

The method of producing an α-Fe/R₂TM₁₄B-type nanocomposite magnet according to the present invention will now be explained in further detail with embodiments. However, the present invention is not limited to the following embodiments.

### Embodiment 1

### Length and Roller Diameter

20 g of a molten alloy (alloy composition Pr₉Fe₇₃Co₉ B₇V₁Nb₁) of 1350° C. was formed into a puddle in a vertical direction (apex) on the surface of a copper roller with a diameter of 500 mm whose surface moves at 14.5 m/sec via an orifice with a diameter of 0.8 mm in an argon gas atmosphere of 60 kPa, and then rapidly solidified. The rapidly solidified ribbon having a width of approximately 2 mm was collected in a flat chute. As a comparative embodiment, a comparative embodiment ribbon was prepared under the same conditions except the diameter of the copper roller was 200 mm.

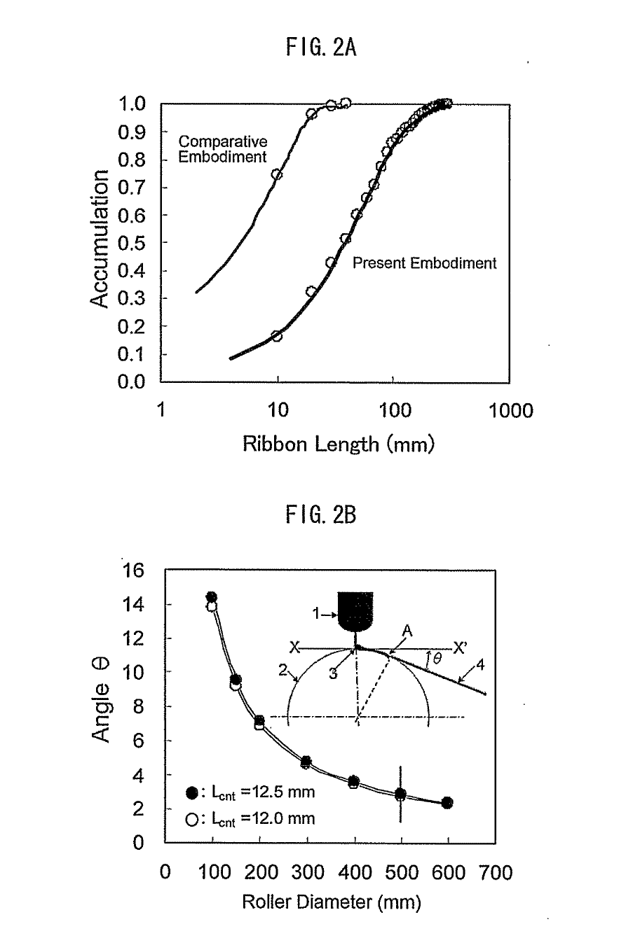

FIG. 2A illustrates the length distribution of a quenched ribbon prepared with the copper roller having a diameter of 500 mm according to the present invention, as well as the length distribution of the comparative embodiment (copper roller having a diameter of 200 mm). As is clear from FIG. 2A, in the comparative embodiment, the proportion of narrow strip-shaped bands of less than 10 mm in length was 75%, and the proportion of narrow strip-shaped flakes of less than 30 mm in length was 99%. In other words, only ribbons with a length on the level of several mm could be obtained (refer to JP-A No. 2003-277892). In contrast, in the ribbons of the present invention, narrow-strip shaped ribbons of less than 10 mm in length made up approximately 17%, and thus the ribbons can be regarded as relatively long. Such relatively long ribbons can be composited with a resin composition and cut into a prescribed length, bent, or punched into an arbitrary shape to yield an α-Fe/R₂TM₁₄B-type nanocomposite magnet of a prescribed shape.

The contact distance L_{cnt} between the puddle 3 and the roller surface 2 did not depend on the roller diameter in the present embodiment and was 12.0 to 12.5 mm in the present alloy system. In order to stably obtain the relatively long ribbon 4 according to the present invention, it is necessary to reduce the trajectory of the arc shape of the ribbon 4 in the contact distance L_{cnt}. For example, in FIG. 2B, if an angle formed by a roller circumferential direction tangent line X-X′ of the puddle 3 and a chord of the arc drawn by the ribbon 4 in a section between the puddle 3 and the separation point A is θ, the linearity of the ribbon 4 that contacts the roller surface 2 increases as the value of θ decreases. From the result in FIG. 2A, if the angle θ is set to approximately 1.4°, the formation of the puddle 3 and the position of the separation point A both stabilize, and the linearity of the ribbon 4 that contacts the roller surface 2 increases. For example, the angle θ when the roller diameter is 500 mm and the contact distance L_{cnt} is a maximum 15 mm is 1.7°, and the linearity of the ribbon 4 on the roller surface 2 is 2.5 times greater than that of the comparative embodiment. This is one reason that the relatively long ribbon 4 becomes easy to obtain.

### Embodiment 2

### Coercivity and Thickness

20 g of a molten alloy (alloy composition Pr₉Fe₇₃Co₉ B₇V₁Nb₁) of 1350° C. was rapidly solidified on the surface of a copper roller with a diameter of 500 mm whose roller surface moves at 10.0, 14.0, 14.5, 15.0, 20.0 and 30.0 m/sec via an orifice with a diameter of 0.8 mm in an argon gas atmosphere of 60 kPa. The quenched ribbon having a width of approximately 2 mm was collected in a flat chute.

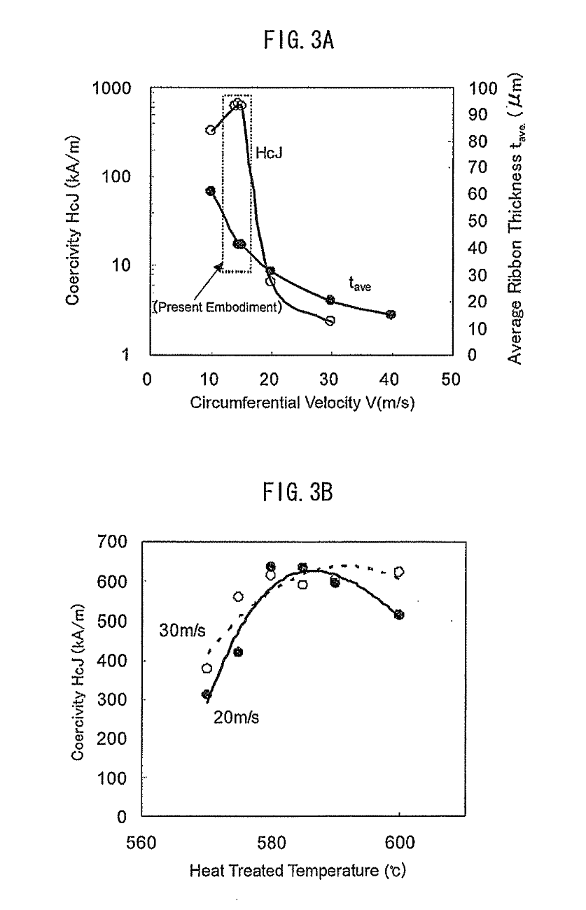

FIG. 3A is a characteristics graph illustrating the relationship of the movement velocity of the copper roller surface with a diameter of 500 mm with the coercivity and with the film thickness, and FIG. 3B is a characteristics graph illustrating the relationship between the heat treatment temperature and the coercivity HcJ of a ribbon prepared when the copper roller surface has a movement velocity of 20 and 30 m/sec. The coercivity is a value at room temperature measured with a VSM (vibrating sample magnetometer) in an external magnetic field of ±2.4 MA/m. The heat treatment raised the temperature to a set temperature at about 10° C./sec in an argon gas flow (1.5 L/min), and then cooled until 100° C. or less in the gas flow without any holding time.

As shown in the embodiment of the present invention in FIG. 3A, the present invention can optimize the movement velocity of the copper roller surface during rapid solidification from the coercivity value. If the movement velocity of the copper roller surface is in the vicinity of 14 to 15 msec, the average coercivity is 686 kA/m. This coercivity hardly changes even upon heat treatment at 570 to 600° C., and actually there is a reduction in the magnetic characteristics due to coarsening of the α-Fe phase and the R₂TM₁₄B phase.

In order to obtain an amorphous quenched ribbon like those in JP-A Nos. 11-026272, 11-016715, and 2001-254159 with this alloy system, it is necessary to set the movement velocity of the copper roller surface to 40 m/sec or more. When the movement velocity of the copper roller surface is 20 and 30 m/see, crystallization is achieved but the coercivity cannot exceed several kA/m, and a heat treatment for crystallization as shown in FIG. 3B is necessary. However, the coercivity of the ribbon that has been heat treated in a temperature range of 570 to 600° C. does not reach a coercivity of 686 kA/m of the non-heat treated ribbon prepared when the movement velocity of the copper roller surface is 14 to 15 msec. The representative magnetic characteristics after a pulsed magnetization of 4.8 MA/m in an in-plane direction in which one side is approximately 2 mm according to the present invention were a remanence of 0.95 T, a coercivity of 652 kA/m, and a (BH)ₘₐₓ of 140 kJ/m³.

A thickness t of the ribbon is limited by t=T_{cnt}×V_{sld}. Also, a relationship of T_{cnt}=L_{cnt}Nᵣₒₗₗ is established. Herein, T_{cnt} is the contact time of the ribbon with the roller surface, V_{sld} is the solidification interface movement velocity, Vᵣₒₗₗ is the movement velocity of the roller surface, and L_{cnt} is the contact distance between the ribbon and the roller surface. In the embodiments of the present invention, when the movement velocity of the roller surface Vᵣₒₗₗ was 14.5 msec, the L_{cnt} was 12.0 to 12.5 mm, t was 41 to 43 μm, and V_{sld} was 50 mm/sec. Given this, in order to produce a quenched ribbon having an amorphicity of 90% or more like those in JP-A Nos. 11-026272, 11-016715, and 2001-254159 with the alloy composition of the present embodiment, it is necessary to set the movement velocity of the roller surface Vᵣₒₗₗ to 40 msec, and the thickness t in this case is approximately 16 μm. At this level of thickness, the ribbon becomes extremely mechanically brittle, and even if collected with a chute the length reaches only several mm or less, and thus the target relatively long ribbon cannot be obtained. Accordingly, the ribbon cannot be subjected directly to, or as ribbon coated with a polymeric film, cutting into an intended length, or being punched into a specific shape.

### Embodiment 3

### Torque and Torque Curve Distortion

The representative magnetic characteristics after a pulsed magnetization of 4.8 M_A/m in an in-plane direction in which one side is approximately 2 mm according to the present invention obtained in Embodiment 1 were a remanence of 0.95 T, a coercivity of 652 kA/m, and a (BH)ₘₐₓ of 140 kJ/m³. This sample was punched into a circular plate shape having a diameter of 1.6 mm by an opposing dies method, and then magnetized in an in-plane direction with a pulsed magnetic field of 4 MA/m.

As a comparative embodiment, a B(boron)-rich master alloy with an alloy composition of Nd_{4.5}Fe₇₀Co₅B_{18.5}Cr₂ corresponding to the range of alloy compositional formula Fe_{100-x-y}RxAy (wherein R is one or more of Pr, Nd, Dy, and Tb; A is one or two of C (carbon) or B (boron); 1≦x<6 at. %; and 15≦y≦30 at. %) disclosed in JP-A No. 11-026272 was melted at high frequency. This molten alloy was formed into a puddle at 1200° C. in a vertical direction (apex) of a copper roller with a diameter of 500 mm whose surface moves at 30.0 m/sec via an orifice with a diameter of 0.8 mm, and then rapidly solidified to yield an amorphous ribbon having a thickness of approximately 45 μm. The ribbon was collected using a flat chute. The obtained amorphous ribbon was nearly continuous in the length direction, but since it flies at a velocity of 30 m/sec, there was a great deal of twisting and warping.

The above ribbon was then nanocrystalline by raising the temperature to 560° C. at about 10° C./sec in the argon gas flow. In X-ray diffraction, the nanocomposite magnet included the three phases of an Fe₃B phase, an α-Fe phase, and an Nd₂Fe₁₄B phase, and the remanence at room temperature measured with a VSM in an external magnetic field of ±2.4 MA/m was 1.1 T, the coercivity was 330 kA/m, and the (BH)ₘₐₓ was 95 kJ/m³. The sample was then punched into a circular plate shape having a diameter of 1.6 mm by an opposing dies method, and then magnetized in an in-plane direction with a pulsed magnetic field of 4 MA/m.

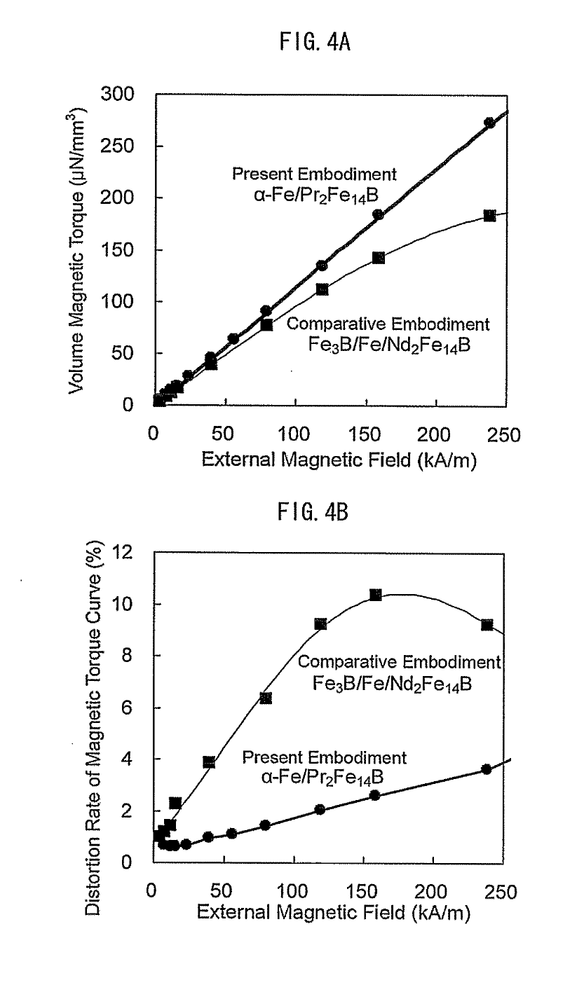

FIG. 4A is a characteristics graph illustrating the magnetic torque relative to the external magnetic field of the samples (number of pole pairs: 2), and FIG. 4B is a characteristics graph illustrating the change in the distortion rate of the magnetic torque curve. Since the diameters of the samples were the same but the thicknesses were different, the magnetic torque is represented by volume magnetic torque found by dividing by the respective volume. The distortion rate of the magnetic torque curve was found by subjecting the magnetic torque curve to Fourier decomposition and then dividing the harmonic wave component by the basic wave component.

A sample magnetized in the in-plane direction with a number of pole pairs of 1 was exposed to a uniformly rotating external magnetic field. Therein, the counterclockwise direction of the rotating direction (direction in which magnetic torque is generated) of the external magnetic field is regarded as positive, and the center at the S-pole of the external magnetic field is considered to turn counterclockwise from directly above the N-pole of the sample. Given this, if the center of the S-pole of the external magnetic field is directly above the N-pole of the sample, the torque is zero. If the center of the S-pole of the external magnetic field rotates counterclockwise, the magnetic torque gradually increases and reaches a maximum magnetic torque at 90° rotation. If the center of the S-pole rotates further, the magnetic torque gradually decreases again and becomes zero at 180°. In other words, the value measured by a torque magnetometer is equivalent to the torque of a DC motor in which the number of pole pairs is 1. When the external magnetic field is changed, a torque gradient dT/dHex relative to an external magnetic field Hex corresponds to a torque constant in a DC motor.

In the sample according to the present invention shown in FIG. 4A, the correlation coefficient at linear approximation between an external magnetic field (corresponding to a current value of the motor) of 8 to 240 kA/m and the torque was 0.9999. The correlation coefficient in the comparative embodiment (corresponding to JP-A No. 11-026272) was 0.9363. In addition, an inclination corresponding to the torque constant in a DC motor was also clearly high in the sample according to the present invention. Further, the distortion rate of the magnetic torque curve shown in FIG. 4B was clearly remarkably lower and more stable in the embodiment of the present invention than in the comparative embodiment in an external magnetic field over a wide range of 8 to 240 kA/m. The distortion rate in an external magnetic field of 40 kA/m was 0.94% in the embodiment of the present invention and 3.84% in the comparative embodiment.

### Embodiment 4

### Initial Irreversible Flux Loss

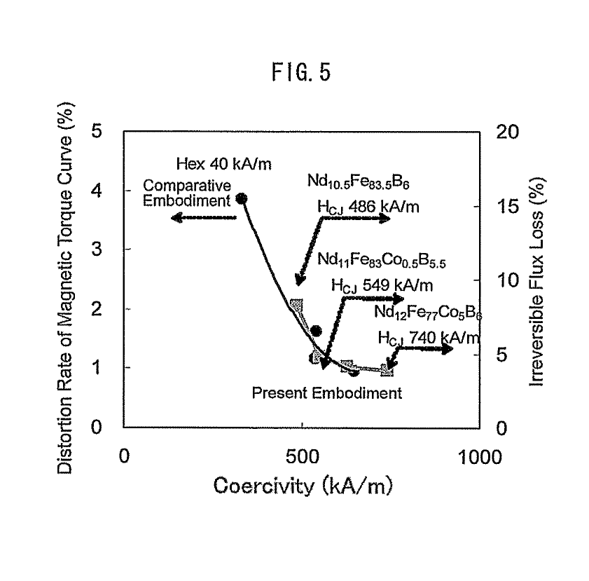

FIG. 5 is a characteristics graph illustrating the relationship between the coercivity and the magnetic torque curve distortion rate in an external magnetic field of 40 kA/m of the embodiment of the present invention described in Embodiment 3 and the comparative embodiment. FIG. 5 also illustrates the relationship between the coercivity and the initial irreversible flux loss of a quenched ribbon in which the main phases are an α-Fe phase and an Nd₂TM₁₄B phase and a bonded magnet produced by crushing a quenched ribbon in which the main phase is an Nd₂Fe₁₄B phase and then pulverizing it and hardening it with a resin. The initial irreversible flux loss rate is the induced voltage reduction rate before and after exposing a stepping motor, in which a magnet in which a cylindrical magnet having a diameter of 4.1 mm is magnetized at 8 poles on the outer periphery is used as a rotor, is exposed for 1 hour to a 120° C. atmosphere.

As is clear from FIG. 5, if the distortion rate of the magnetic torque curve exceeds 1.2%, the initial irreversible flux loss rate also tends to sharply increase. In this way, the distortion rate of the magnetic torque curve and the initial irreversible flux loss in exposure to high temperature are both derived from magnetization reversal. The embodiment of the present invention exhibits magnetic stability equivalent to that of a bonded magnet produced by crushing a quenched ribbon of several μm in length having an alloy composition Nd₁₂Fe₇₇Co₅B₆, or in other words near R₂TM₁₄B stoichiometry, and then hardening with a resin. Further, according to the embodiment of the present invention, since it is possible to obtain a relatively long ribbon, similar to the comparative embodiment (corresponding to JP-A No. 11-026272), the ribbon can be coated with a polymeric film and then cut into a prescribed length or punched into a specific shape to yield an α-Fe/Nd₂TM₁₄B-type nanocomposite magnet.

What is claimed is:

1. A method of producing an α-Fe/R₂TM₁₄B-type nanocomposite magnet where R is 9 at. % or more but less than 11.76 at. % of Nd or Pr, TM is Fe or a substance in which a portion of Fe is substituted with Co of 20 at. % or less, and B is 6 to 8 at. %, wherein a relatively long length nanocrystalline ribbon having a coercivity of 600 kA/m or more in which a content of relatively short ribbon of less than 10 mm in length is 20% or less is coated with a polymeric film and then cut into an intended length, or punched into a specific shape.

2. The method of producing an α-Fe/R₂TM₁₄B-type nanocomposite magnet according to claim 1, wherein the nanocrystalline ribbon is produced by rapidly solidifying at a roller surface contact distance of 10 to 15 mm from a puddle of an R-TM-B-type molten alloy of 1300° C. or more formed in a vertical direction of a copper single roller with a diameter of 500 mm or more whose surface moves at a circumferential velocity of 14 to 15 m/sec in an argon gas atmosphere of 50 to 90 kPa.

3. The method of producing an α-Fe/R₂TM₁₄B-type nanocomposite magnet according to claim 2, wherein an angle formed by a circumferential direction tangent line that contacts the roller at the center of the puddle and a chord of a contact curve drawn by the ribbon from the puddle to a separation point is 1.7° or less.

4. The method of producing an α-Fe/R₂TM₁₄B-type nanocomposite magnet according to claim 1, wherein a distortion rate of a magnetic torque curve in an external magnetic field of 40 kA/m of a circular plate of the nanocrystalline ribbon that is magnetized in an in-plane direction at 2.4 MA/m or more is 1.2% or less.

5. The method of producing an α-Fe/R₂TM₁₄B-type nanocomposite magnet according to claim 2, wherein the nanocrystalline ribbon that flies is collected with a flat chute.
